(19) United States
(12) Patent Application Publication
(10) Pub. No.: US 2021/0049390 A1
(43) Pub. Date: Feb. 18, 2021

(54) IMAGE PROCESSING METHOD AND APPARATUS, TERMINAL DEVICE, SERVER AND SYSTEM

(71) Applicant: BEIJING SENSETIME TECHNOLOGY DEVELOPMENT CO., LTD., Beijing (CN)

(72) Inventors: Chunhu WU, Beijing (CN); Qian CHEN, Beijing (CN)

(21) Appl. No.: 17/080,211

(22) Filed: Oct. 26, 2020

Related U.S. Application Data
(63) Continuation of application No. PCT/CN2019/088432, filed on May 24, 2019.

(30) Foreign Application Priority Data
Sep. 10, 2018 (CN) 201811051583.5

(51) Int. Cl. G06K 9/00; G06K 9/62

(52) U.S. Cl. CPC G06K 9/00892; G06K 9/00281; G06K 9/00369; G06K 9/6215; G06K 9/00926; G06K 9/00288

(57) ABSTRACT

An image processing method includes: processing a first image to obtain a first face in the first image; determining whether at least one human body corresponding to the first image comprises a human body matching the first face; and sending a first person recognition request message to a server according to a determination result.

### CROSS-REFERENCE TO RELATED APPLICATIONS

This application is a continuation of International Application No. PCT/CN2019/088432, filed on May 24, 2019, which claims priority to Chinese patent application No. 201811051583.5, filed on Sep. 10, 2018. The disclosures of International Application No. PCT/CN2019/088432 and Chinese patent application No. 201811051583.5 are hereby incorporated by reference in their entireties.

### BACKGROUND

Considering practical requirements, some enterprises or organizations, etc., may need to perform tracking and recognition on people flows in public places for statistics of visits, person identity recognition, person feature analysis and the like.

In related arts, face tracking is adopted for tracking and recognition, and feature matching and analysis is performed on a face in a picture captured by a camera to recognize facial information. However, the accuracy of the tracking and recognition result obtained by the method in the related arts is not high.

### SUMMARY

Embodiments of the disclosure relate to computer technologies, and particularly to an image processing method and apparatus, a terminal device, a server and a system.

The embodiments of the disclosure provide technical solutions to image processing.

A first aspect provides an image processing method, which may include that: a first image is processed to obtain a first face in the first image; it is determined whether at least one human body corresponding to the first image includes a human body matching the first face; and a first person recognition request message is sent to a server according to a determination result.

A second aspect provides an image processing method, which may include that: a person recognition request message sent by a first terminal device is received, the person recognition request message including image information of a first human body; and person ID information of a person to which the first human body belongs is determined based on the image information of the first human body.

A third aspect provides an image processing apparatus, which may include: a memory storing processor-executable instructions; and a processor arranged to execute the stored processor-executable instructions to perform operations of: processing a first image to obtain a first face in the first image; determining whether the at least one human body corresponding to the first image comprises the human body matching the first face; and sending a first person recognition request message to a server according to a determination result.

### BRIEF DESCRIPTION OF THE DRAWINGS

In order to describe the technical solutions in the disclosure or a conventional art more clearly, the drawings required to be used in descriptions about the embodiments or the conventional art will be simply introduced below. It is apparent that the drawings described below are some embodiments of the disclosure. Other drawings may further be obtained by those of ordinary skill in the art according to these drawings without creative work.

FIG. 1 is a schematic diagram of a system architecture according to an embodiment of the disclosure.

FIG. 2 is a flowchart of an image processing method according to an embodiment of the disclosure.

FIG. 3 is another flowchart of an image processing method according to an embodiment of the disclosure.

FIG. 4 is another flowchart of an image processing method according to an embodiment of the disclosure.

FIG. 5 is another flowchart of an image processing method according to an embodiment of the disclosure.

FIG. 6 is another flowchart of an image processing method according to an embodiment of the disclosure.

FIG. 7 is a module structure diagram of an image processing apparatus according to an embodiment of the disclosure.

FIG. 8 is another module structure diagram of an image processing apparatus according to an embodiment of the disclosure.

FIG. 9 is another module structure diagram of an image processing apparatus according to an embodiment of the disclosure.

FIG. 10 is another module structure diagram of an image processing apparatus according to an embodiment of the disclosure.

FIG. 11 is another module structure diagram of an image processing apparatus according to an embodiment of the disclosure.

FIG. 12 is a module structure diagram of another image processing apparatus according to an embodiment of the disclosure.

FIG. 13 is another module structure diagram of another image processing apparatus according to an embodiment of the disclosure.

FIG. 14 is another module structure diagram of another image processing apparatus according to an embodiment of the disclosure.

FIG. 15 is another module structure diagram of another image processing apparatus according to an embodiment of the disclosure.

FIG. 16 is another module structure diagram of another image processing apparatus according to an embodiment of the disclosure.

FIG. 17 is another module structure diagram of another image processing apparatus according to an embodiment of the disclosure.

FIG. 18 is another module structure diagram of another image processing apparatus according to an embodiment of the disclosure.

FIG. 19 is a schematic block diagram of a terminal device according to an embodiment of the disclosure.

FIG. 20 is a schematic block diagram of a server according to an embodiment of the disclosure.

FIG. 21 is an architecture diagram of an image processing system according to an embodiment of the disclosure.

### DETAILED DESCRIPTION

In order to make the purpose, technical solutions and advantages of the disclosure clearer, the technical solutions in the embodiments of the disclosure will be clearly and completely described below in combination with the drawings in the embodiments of the disclosure. It is apparent that the described embodiments are not all embodiments but part of embodiments of the disclosure. All other embodiments obtained by those of ordinary skill in the art based on the embodiments in the disclosure without creative work shall fall within the scope of protection of the disclosure.

In the related art, person tracking and recognizing is performed based mainly on facial information. However, in a practical environment, consequences of missing detection, poor detection quality and the like may be caused by occlusions, shooting angles and other problems, and thus the accuracy of a tracking and recognition result obtained by face tracking and recognition is not so high. Based on the problem, the embodiments of the disclosure disclose an image processing method. A client matches a face and a human body and sends a person recognition request message to a server according to a matching result. Since matching is simultaneously performed on the face and the human body, the accuracy of a tracking and recognition result may be greatly improved. In addition, after the matching result is sent to the server, the server may further accurately analyze customer data according to the matching result.

The methods provided in the embodiments of the disclosure may be applied to various scenarios requiring person tracking and recognition. For example, in a scenario such as a supermarket and a retail store, a manager of the supermarket or the retail store may need to perform tracking and recognition on the customer flow in the supermarket or the retail store to obtain information of customer flow statistics, customer recognition, customer visits and the like and further use the information as important reference information for enterprise management. For another example, in a surveillance scenario of a public place such as a crossroad and a railway station, identity information of some specific persons and the like may be determined by person tracking and recognition in such a scenario.

The solutions of the embodiments of the disclosure will be described in the following embodiment of the disclosure with a retail store scenario as an example, but it is apparent that the embodiments of the disclosure are not limited thereto.

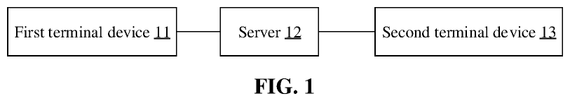

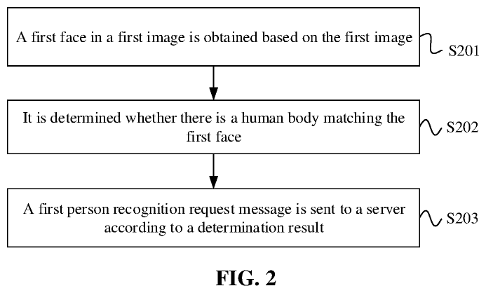

FIG. 1 is a schematic diagram of a system architecture according to an embodiment of the disclosure. As shown in FIG. 1, the architecture includes a first terminal device 11, a server 12 and a second terminal device 13. In the retail store scenario, a client runs in the first terminal device, and the first terminal device is deployed in the retail store and connected with a camera arranged in the retail store, and acquires a video image captured by the camera and performs processing such as tracking and matching. The client in the first terminal device is connected with the server, and the server, after receiving data from the client in the first terminal device, performs recognition processing and sends a processing result to a client in the second terminal device. The client in the second terminal device may be a management system of a manager of the retail store and the like, and the client in the second terminal device may analyze information sent by the server to obtain information of customer flow statistics, customer recognition, customer visits and the like.

The solutions of the embodiments of the disclosure will be described in the following embodiments of the disclosure from the angle of the client and the server respectively. A processing process of the client will be described at first below. An embodiment of the disclosure provides an image processing method, as shown in FIG. 2. An execution body of the method is the client, or may also be another terminal device. No limits are made thereto in the embodiment of the disclosure. For ease of understanding, descriptions will be made below with execution of the method by the client as an example. The method shown in FIG. 2 includes the following operations.

In S201, a first image is processed to obtain a first face in the first image.

The first image may be a frame of image in a video sequence shot by a camera in real time, or the first image may be a static image. Specific implementation of the first image is not limited in the embodiments of the disclosure.

In some embodiments, a continuous video stream is shot by the camera in real time, and the camera may send the video stream to the client in real time or periodically. The client may decode the video stream to obtain the video sequence. The video sequence includes multiple frames of images. The client may further process the multiple frames of images or part of images in the multiple frames of images by use of the method of the embodiment of the disclosure respectively.

In some embodiments, the video sequence or the first image may also be acquired in another manner. A specific acquisition manner is not limited in the embodiments of the disclosure. In some embodiments, the client may select the first image from the multiple images in the video sequence. For example, the client may select the first image from a preset number of consecutive images in the video sequence, or, the client may also select the first image from the video sequence based on a preset threshold. However, specific implementation of frame selection is not limited in the embodiments of the disclosure.

In some embodiments, the client may select the first image from the multiple images in the video sequence based on quality of faces in the images. Exemplarily, the client may select a frame with best quality from Q (Q is an integer, for example, 10) frames of consecutive images in the video sequence as the first image. For example, a quality score of each image may be determined, and the image with the highest quality score is determined as the first image. The quality score may be obtained based on one or more factors of the image. For example, the quality score of the image may be determined based on one or any combination of a face definition, a face angle, a face size, a face detection confidence and the like, or the quality score of the image may also be determined based on another factor. In addition, the quality score of the image may be obtained in multiple manners. For example, the quality score of the image may be determined based on a neural network, or the quality score of the image may be obtained based on another algorithm. Both an obtaining manner and influencing factor of the quality score are not limited in the embodiment of the disclosure.

For another example, the client may select an image of which the quality score reaches a preset threshold from the video sequence as the first image. In an example, a comprehensive quality score of the image may be determined, and whether to select the image may be determined based on whether the comprehensive quality score reaches the preset threshold. Or, a threshold of each quality factor of the image may be set, for example, a threshold is set for one or each of multiple of the face angle, the face size and the face definition, and whether to select the image may be determined based on whether each quality factor reaches the corresponding threshold. Or, the comprehensive quality score and the threshold corresponding to each quality factor may also be set. Specific implementation thereof is not limited in the embodiments of the disclosure.

As an optional implementation, the client may perform face detection on the first image to obtain the first face, and in such case, the client may obtain an image of the first face and ID information of the first face, for example, a bounding box ID of the first face. Or, the client may perform face tracking on the first image to obtain the first face in the first image, and in such case, as another implementation, the client may obtain the image of the first face and tracking ID information of the first face.

In some embodiments, the client may perform face tracking based on a face key point. For example, the client may perform face detection on a second image before the first image to obtain a face image and perform key point detection on the face image to obtain position information of a key point in the second image. An interval between the second image and the first image may be less than a preset numerical value. Then, the client may determine predicted position information of the key point in the first image based on the position information of the key point in the second image and motion information, for example, optical flow information, of the first image relative to the second image, and acquire the image of the first face based on the predicted position information of the key point in the first image.

In some embodiments, face tracking may also be performed based on another manner. Specific implementation of face tracking is not limited in the embodiments of the disclosure. In some embodiments, after the first face is obtained by face tracking, the client may further record a frame ID of the image where the first face is located.

In S202, it is determined whether at least one human body corresponding to the first image includes a human body matching the first face.

In some embodiments, whether the at least one human body in the first image includes the human body matching the first face may be determined.

In the embodiment of the disclosure, information of the at least one human body in the first image may be obtained in multiple manners. In some embodiments, human body detection may be performed on the first image to obtain the at least one human body in the first image, and in such case, as an implementation, an image of each human body and ID information of each human body, for example, a bounding box ID, may be obtained. In some other possible implementations, human body tracking may be performed on the first image to obtain the at least one human body in the first image. For example, human body tracking may be performed on at least part of images in the video sequence to which the first image belongs to obtain a human body tracking result, the human body tracking result including human body tracking information of at least one image in the video sequence. In such case, as another implementation, the image of each human body and tracking ID information of each human body may be obtained. As another implementation, for each human body, the client may further record a frame ID of the image where the human body is located, but the embodiment of the disclosure is not limited thereto.

In some embodiments, before the operation that it is determined whether the at least one human body corresponding to the first image includes the human body matching the first face, the method further includes that: human body tracking is performed on at least part of images in the video sequence to which the first image belongs to obtain the human body tracking result of the video sequence; and the human body tracking result of the video sequence is searched for the human body tracking information of the first image based on a frame number of the first image.

In some embodiments, the human body tracking result of the at least part of images of the video sequence may be searched for the human body tracking information corresponding to the frame number of the first face. Under a condition, if there is the human body tracking information corresponding to the frame number of the first face in the human body tracking result, the human body tracking information corresponding to the frame number of the first image is searched for the human body matching the first face. Under another condition, if there is no human body tracking information corresponding to the frame number of the first face in the human body tracking result, human body detection may be performed on the first image, and whether the at least one human body obtained by performing human body detection on the first image includes the human body matching the first face may be determined. In some other possible implementations, human body detection may be directly performed on the first image, and whether the at least one human body obtained by performing human body detection on the first image includes the human body matching the first face may be determined.

A manner for obtaining the at least one human body in the first image is not limited in the embodiments of the disclosure.

In S203, a first person recognition request message is sent to a server according to a determination result.

In some embodiments, the determination result includes that there is the human body matching the first face or there is no human body matching the first face.

In some embodiments, the first person recognition request message further includes ID information of the first face.

For different determination results, the client may send different first person recognition request messages to the server. That is, for different determination results, the first person recognition request message may include different information. For example, whether to perform person recognition on the first face based on image information of the human body may be determined based on the determination result, namely whether there is the human body matching the first face. For another example, whether the first person recognition request message includes image information of the first face may be determined based on the determination result.

In the embodiment of the disclosure, the client matches the face and the human body and sends the person recognition request message to the server according to a matching result, which is favorable for improving accuracy in person recognition. In some embodiments, in a monitoring scenario of a target region, cameras may usually be arranged at one or more positions, and for factors such as light, occlusion and the face angle, person recognition may not be performed on the face, or the person recognition accuracy is relatively low. In the embodiment of the disclosure, it is determined whether there is the human body matching the first face, and whether the first person recognition request message sent to the server includes the image information of the first face is determined based on the matching result, thus it is favorable for improving accuracy in person recognition.

Based on the abovementioned embodiments, how to send the first person recognition request message to the server according to the determination result will be described below. As mentioned above, the determination result may include that there is the human body matching the first face or there is no human body matching the first face. Processing manners under the two conditions will be described below respectively.

1. There is the human body matching the first face.

In some embodiments, when there is the human body matching the first face (the matching human body is referred to as a first human body), the client may send the first person recognition request message including image information of the first human body to the server.

In a possible implementation, responsive to that there is the human body matching the first face, it may be directly determined that the first person recognition request message includes the image information of the first face. In such case, as an implementation, the first person recognition request message may further include the image information of the first face, and correspondingly, the server, after receiving the first person recognition request message, may perform person recognition based on the image information of the first face and the image information of the first human body. Or, the first person recognition request message may also not include the image information of the first face, and correspondingly, the server, after receiving the first person recognition request message, may perform person recognition based on the image information of the first human body. No limits are made thereto in the embodiment of the disclosure.

In another possible implementation, image quality of the first human body may be judged, and whether the first person recognition request message includes the image information of the first human body may be determined based on first image quality. As an implementation, whether the image quality of the first human body meets a preset quality requirement may be judged to determine whether the first person recognition request message includes the image information of the first human body.

Under a condition, if the image quality of the first human body meets the quality requirement, the first person recognition request message sent to the server includes the image information of the first human body. Correspondingly, the server may perform person recognition based on the image information of the first human body. For example, the server may acquire the image information of the first face from the image information of the first human body, for example, cropping the image of the first face from an image of the first human body, and perform person recognition based on the image information of the first face. However, the embodiment of the disclosure is not limited thereto.

Under another condition, if the image quality of the first human body does not meet the quality requirement, the first person recognition request message sent to the server does not include the image information of the first human body but only includes the image information of the first face, the image information of the first face being used by the server for performing person recognition.

Accordingly, in the technical solution of the embodiment of the disclosure, whether to perform person recognition based on the image information, obtained by human body detection or human body tracking, of the human body or based on the image information, obtained by face detection or face tracking, of the face may be determined according to a practical condition of the image. For example, when the image quality of the human body is relatively good, the image information of the face is acquired from the image information of the human body for performing person recognition; and when the image quality of the human body is relatively poor, person recognition is performed by use of the image information, obtained by face detection or face tracking, of the face. Therefore, it is possible to solve the problem of relatively low recognition accuracy caused by the factors such as the face angle and occlusion during person recognition, and it is possible to improve accuracy in person recognition.

In the embodiment of the disclosure, the quality requirement may be set according to a practical condition. In a possible implementation, the quality requirement may include one or any combination of the following requirements: a face definition requirement, a face size requirement, a face angle requirement, a face detection confidence requirement, a human body detection confidence and a face integrity requirement.

In an example, the quality requirement includes at least one of the following combination: a confidence of a human body bounding box reaches a preset threshold, face integrity meets a specific requirement (for example, the whole human body is included), a face definition meets a specific requirement, a face size meets a specific requirement or a face angle is in a specific range. In such case, the server may acquire a face image with relatively good quality from the image of the human body and perform person recognition based on the face image, so that it is possible to improve accuracy in person recognition.

As an implementation, the quality requirement may also include another type of parameter requirement, and specific implementation thereof is not limited in the embodiments of the disclosure. In the embodiment of the disclosure, if it is determined in any abovementioned manner that the first person recognition request message sent to the server includes the image information of the first human body, in an example, the message may further include the image information of the first face, and in such case, the server, after receiving the first person recognition request message, may select to perform person recognition by use of the image information of the first face or image information of the first human body in the message or perform person recognition by combining the two. No limits are made thereto in the embodiment of the disclosure. In another example, the message may not include the image information of the first face, and correspondingly, before the message is sent, the image information of the first face may be determined to be replaced with the image information of the first human body, thereby including the image information of the first human body rather than the image information of the first face in the first person recognition request message. Correspondingly, the server, after receiving the first person recognition request message, performs person recognition based on the image information of the first human body in the message. However, the embodiment of the disclosure is not limited thereto.

2. There is no human body matching the first face.

In some embodiments, responsive to that there is no human body matching the first face, the client may send the first person recognition request message including the image information of the first face to the server. In such case, the first person recognition request message corresponding to the first face may include the image information of the first face, the image information of the first human body, or both the image of the first human body and the image information of the first face.

In the embodiment of the disclosure, in a possible implementation, the image information of the first human body includes the image of the first human body. In such case, the server may perform person recognition based on the image of the first human body. For example, the server acquires the image of the first face from the image of the first human body and performs person recognition based on the image of the first face and a face template. For another example, person recognition is performed based on the image of the first human body, a human body template and a person-human body association database, etc. Specific implementation of the operation that the server performs person recognition based on the image of the first human body is not limited in the embodiments of the disclosure.

In another possible implementation, the image information of the first human body includes feature information of the image of the first human body. As an implementation, the feature information of the image of the first human body may include human body feature information, or include face feature information, or include both the human body feature information and the face feature information. The human body feature information of the image of the first human body is obtained by performing feature extraction on the image of the first human body, and the face feature information of the image of the first human body is obtained by performing feature extraction on a face region image in the image of the first human body. In some embodiments, the image information of the first face includes the image of the first face and/or feature information of the image of the first face. The feature information of the image of the first face is obtained by performing feature extraction on the image of the first face. No limits made thereto in the embodiment of the disclosure. As an implementation, the first person recognition request message includes the image information of the first human body and/or the image information of the first face, and may further include the ID information of the first face, for example, the tracking ID information or bounding box ID information. The server, after acquiring the information, may perform person identity recognition and/or further analysis processing according to the information more accurately.

For ease of understanding, the term “image information of the first human body” refers to image information obtained by performing human body detection or human body tracking on the image. In addition, in the abovementioned embodiments, the term “image information of the first face” refers to image information obtained by performing face detection or face tracking on the image. In the following embodiments, the term “image information of the first face” may also refer to image information, obtained based on the image information of the human body in the message, of the face.

In addition, it is to be understood that the term “first person recognition request message” refers to a person recognition request message of requesting for recognizing a person obtained by face detection or face tracking, and the term “second person recognition request message” refers to a person recognition request message of requesting for recognizing the person obtained by human body detection or human body tracking. Moreover, the client may further perform human body detection or tracking on the first image to obtain a human body detection or tracking result and send the human body detection or tracking result to the server.

In an example, the client may perform human body tracking or detection on the first image to obtain a second human body in the first image and send a second person recognition request message to the server, the second person recognition request message including image information of the second human body and ID information of the second human body. The image information of the second human body may include an image of the second human body and/or human body feature information of the image of the second human body. No limits are made thereto in the embodiment of the disclosure. The server, after receiving the second person recognition request message, may perform person recognition based on the image information of the second human body.

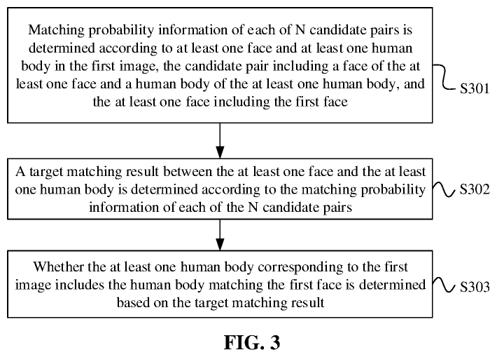

FIG. 3 is another flowchart of an image processing method according to an embodiment of the disclosure.

In S301, matching probability information of each of N candidate pairs is determined according to at least one face and at least one human body in the first image, the candidate pair including a face of the at least one face and a human body of the at least one human body, the at least one face including the first face and N being an integer more than or equal to 1.

In some embodiments, face detection or tracking may be performed on the first image to obtain the at least one face, and human body detection or tracking may be performed on the first image to obtain the at least one human body.

In some embodiments, after at least one first face and at least one first human body are obtained, any face-human body combination of the at least one human body and the at least one face may be determined as a candidate pair, to obtain the N candidate pairs, namely N=(n1×n2)/2, where n1 and n2 are a number of the at least one face and a number of the at least one human body respectively. Or, part of face-human body combinations of the at least one human body and the at least one face may be determined as candidate pairs, to obtain the N candidate pairs. Specific implementation of the N candidate pairs is not limited in the embodiments of the disclosure.

In an implementation, after the at least one face and the at least one human body are obtained, based on each face, candidate pairs with each human body or part of human bodies in the at least one human body may be formed. In another implementation, after the at least one face and the at least one human body are obtained, based on each human body, candidate pairs with each face or part of faces in the at least one face may be formed.

In some embodiments, the matching probability information of the candidate pair is configured to identify a matching degree of the face and human body in the candidate pair. In an example, the matching probability information may include a matching probability, and if the matching probability of the candidate pair is higher, it is indicated that the matching degree of the face and human body in the candidate pair is higher. In another example, the matching probability information may include a matching weight, and if the matching weight of the candidate pair is smaller, it is indicated that the matching degree of the face and human body in the candidate pair is higher. No limits are made thereto in the embodiment of the disclosure.

In the embodiment of the disclosure, the matching probability information of each of the N candidate pairs may be obtained in multiple manners. In an example, the matching probability information of each of the N candidate pairs is obtained based on machine learning or another matching algorithm. For example, image information of the face and human body in the candidate pair may be input to a neural network for processing, and the matching probability information of the candidate pair is output. However, specific implementation of obtaining the matching probability information of the candidate pair is not limited in the embodiments of the disclosure.

In S302, a target matching result between the at least one face and the at least one human body is determined according to the matching probability information of each of the N candidate pairs.

In some embodiments, each matching face-human body pair in the at least one human body and the at least one face may be determined based on the matching probability information of each of the N candidate pairs. For example, the target matching result may include n1 matching face-human body pairs, and in such case, there is a paired human body for each of the n1 faces. n1 may be less than n2, and in such case, there are no paired faces for part of the n2 human bodies. Or, n1 is equal to n2, and in such case, the n1 faces match the n2 human bodies in a one-to-one corresponding manner. For another example, the target matching result may include n2 matching face-human body pairs, n2 being less than n1, and in such case, there is a matching face for each of the n2 human bodies but there are no matching human bodies for part of the n1 faces. For another example, the target matching result may include n3 matching face-human body pairs, n3 being less than n1 and n2, and in such case, part of the n1 faces and part of the n2 human bodies are paired. Specific implementation of the target matching result is not limited in the embodiments of the disclosure.

In S303, whether the at least one human body corresponding to the first image includes the human body matching the first face is determined based on the target matching result.

In some embodiments, the target matching result between the at least one face and the at least one human body includes at least one pair of matching human body and face (i.e., at least one matching face-human body pair). Correspondingly, the target matching result may be searched for the first face to determine whether there is the human body matching the first face. In some embodiments, if there is the human body matching the first face, information of the human body matching the first face may further be acquired.

In an implementation, the matching probability information of a first candidate pair in the N candidate pairs may be determined in the following manner. The first candidate pair may be any candidate pair in the N candidate pairs, and the first candidate pair includes a second face and the second human body. Estimated position information and actual position information of a target object are determined based on the second human body in the first candidate pair and the second face in the first candidate pair, the target object being a part of the human body. Then, the matching probability information of the first candidate pair is determined based on the estimated position information of the target object and the actual position information of the target object.

In some embodiments, the target object may be a part of the human body, for example, an ear, a face or a certain organ like an eye and nose on the face, and may also be another part of the human body. Specific implementation of the target object is not limited in the embodiments of the disclosure. In a possible implementation, the estimated position information of the target object may be determined based on one of the second human body and the second face, and the actual position information of the target object may be determined based on the other. Therefore, a matching degree of the second face and second human body in the first candidate pair may be determined based on the estimated position information and actual position information of the target object, for example, by comparing the estimated position information and actual position information of the target object or determining a distance between an estimated position corresponding to the estimated position information of the target object and an actual position corresponding to the actual position information. However, no limits are made thereto in the embodiment of the disclosure.

In the embodiment of the disclosure, determination of the actual position information and estimated position information of the target object may be simultaneously executed or executed in any sequence, and no limits are made thereto in the embodiment of the disclosure. In an example, the target object is an ear. In such case, an estimated position and actual position of the ear may be obtained based on the second human body and the second face, and furthermore, the matching probability information of the second human body and the second face may be determined according to a difference, for example, a distance, between the estimated position and the actual position.

An example of obtaining the estimated position and actual position of the ear based on the second human body and the second face will be described below in detail. In some embodiments, in S301, actual position information of the ear is determined based on the second human body, and estimated position information of the ear is determined based on the second face. In the embodiment of the disclosure, the actual position information of the ear may be determined in multiple manners or based on the second human body. In an example, the second human body obtained by the client includes the image of the second human body, and in such case, key point detection may be performed on the image of the second human body to obtain position information of a key point of the ear, the actual position information of the ear including the position information of the key point of the ear. In another example, the second human body obtained by the client includes position information of the second human body. In such case, the image of the second human body may be acquired from the first image based on the position information of the second human body, and key point detection may be performed on the image of the second human body to obtain the position information of the key point of the ear. Or, the client may also determine the actual position information of the ear in another manner. No limits are made thereto in the embodiment of the disclosure.

In some embodiments, the position information of the key point of the ear may include position information of a key point of at least one ear, namely including position information of a key point of the left ear and/or position information of a key point of the right ear. No limits are made thereto in the embodiment of the disclosure. In some embodiments, key point detection may be performed on the image of the second human body through the neural network. For example, a pre-trained key point detection model may be adopted. The image of the second human body is input to the key point detection model, and the key point detection model may output key point information of the ear in the second human body. Or, key point information of the image of the second human body may also be obtained through another key point detection algorithm. No limits are made thereto in the embodiment of the disclosure. In the embodiment of the disclosure, the client may determine the estimated position information of the ear based on the second face in multiple manners. As an implementation, the estimated position information of the ear is determined based on position information of a face limiting box of the second face or the position information of the second face. In a possible implementation, the estimated position information of the ear may be determined based on a position of a center point of the second face and size information of the second face.

In some embodiments, the size information of the second face may include a height and width of the second face, etc.

In another possible implementation, the estimated position information of the ear may be determined based on position information of multiple vertexes of the face limiting box of the second face. In some embodiments, the face limiting box of the second face may be acquired at first, and the height and width of the face may be obtained based on information of the face limiting box. For example, face detection or face tracking is performed on at least part of the first image to obtain the face limiting box of the second face, and the information of the face limiting box may include the position information of the face limiting box, for example, including coordinates of the multiple vertexes in the image or including the position of the center point and width and height of the face limiting box. In an example, the height of the face may be equal to the height of the face limiting box, and the width of the face may be equal to the width of the face limiting box. However, no limits are made thereto in the embodiment of the disclosure.

In a possible implementation, the estimated position information of the ear may be determined through a Gaussian distribution model. The estimated position information of the ear may include an estimated position of the left ear and/or an estimated position of the right ear.

For example, an estimated position of the ear may be obtained through Formula (1).

\vec{P_{face}}±\vec{(θₓ*F_{w}+θ_{y}*Fₕ)} (1)

θₓ and θ_{y} are estimated position parameters of the ear and may be manually set or obtained by training, \vec{P_{face}} is the position of the center point of the second face, F_{w} is the width of the second face, and Fₕ is the height of the second face.

In another possible implementation, the estimated position information of the ear may be determined through the neural network. In such case, the image of the second face is input to the neural network and processed to obtain the estimated position information of the ear. However, no limits are made thereto in the embodiment of the disclosure.

The client, after determining the estimated position information and actual position information of the ear, determines first matching probability information of the first candidate pair based on the estimated position information of the ear and the actual position information of the ear.

In some embodiments, a distance between a position corresponding to the actual position information of the ear and a position corresponding to the estimated position information of the ear may be calculated, a probability density may be obtained according to the distance and a model parameter in the Gaussian distribution model, and the probability density may be determined as a matching probability of the first candidate pair, or, the matching probability of the first candidate pair may be determined through the probability density. No limits are made thereto in the embodiment of the disclosure.

In another example, the target object is a face. In such case, as an implementation, estimated position information of the second face may be determined based on the second human body, and the matching probability information of the first candidate pair may be determined based on the estimated position information of the second face and actual position information of the second face. In some embodiments, estimated position information of a center point of the second face may be determined based on limiting box information of the second human body. Moreover, actual position information of the center point of the second face may be determined based on the position information of the second face. Then, the matching probability information of the first candidate pair may be determined based on the estimated position information of the center point of the second face and the actual position information of the center point of the second face.

A process of determining the actual position information of the center point of the second face based on the position information of the second face may refer to the descriptions in the abovementioned embodiment and will not be elaborated herein. The client may determine the estimated position information of the center point of the second face in multiple manners according to the position information of the second human body (i.e., position information of a human body limiting box). As an implementation, the client may determine at least one of vertex coordinates of the human body limiting box, a human body height or a human body width according to the position information of the human body limiting box. Furthermore, the estimated position information of the center point of the second face is determined according to at least one of the vertex coordinates, the human body height or the human body width.

In an example, the estimated position of the center point of the second face may be determined through the Gaussian distribution model.

For example, the estimated position of the center point of the second face is obtained through Formula (2).

Bₓ₁+μₓ*B_{w}, B_{y1}+μ_{y}*Bₕ (2).

Bₓ₁ and B_{y1} are the vertex coordinates of the human body limiting box, μₓ and μ_{y} are estimated position parameters of the center point of the second face and may be preset or obtained by training, B_{w} is the human body width and Bₕ is the human body height.

In another example, face detection may be performed on the image of the second human body, and the estimated position information of the second face may be determined based on a detection result. For example, the position information of the detected face bounding box is determined as the estimated position information of the center point of the second face.

In another example, the estimated position information of the center point of the second face may be determined through the neural network. In such case, the image of the second human body is input to the neural network and processed to obtain the estimated position information of the center point of the second face. However, no limits are made thereto in the embodiment of the disclosure.

After the estimated position information and actual position information of the center point of the second face are obtained, the matching probability information of the first candidate pair may be determined based thereon.

In some embodiments, a two-dimensional Gaussian function may be created according to the estimated position of the center point of the first face and the actual position of the center point of the first face, thereby obtaining a probability density, and the probability density is determined as the matching probability of the first candidate pair, or, the matching probability of the first candidate pair may be determined through the probability density. No limits are made thereto in the embodiment of the disclosure.

In S302, the target matching result between the at least one face and the at least one human body may be determined in the following manner: matching probability information of each of at least one candidate matching result between the at least one face and the at least one human body is determined according to the matching probability information of each of the N candidate pairs, the candidate matching result including m of the N candidate pairs, every two of the m candidate pairs including different faces and different human bodies, where 1≤m≤N; and the target matching result between the at least one face and the at least one human body is determined from among the at least one candidate matching result based on the matching probability information of each of the at least one candidate matching result.

In some embodiments, the candidate matching result is a set of the m candidate pairs, and the candidate pairs in the set are not repeated, namely every two of the m candidate pairs in the candidate matching result include different faces and different human bodies That is, the candidate matching result is a set of m face-human body pairs that are hypothesized to be matching among the N candidate pairs.

In some embodiments, m may be equal to the number of the at least one human body or the at least one face. Or, filtering processing may be performed on the N candidate pairs based on the matching probability information of each of the N candidate pairs to obtain M candidate pairs, and the at least one candidate matching result is obtained based on the M candidate pairs. In such case, m may be smaller than the number of the at least one face and smaller than the number of the at least one face. However, no limits are made thereto in the embodiment of the disclosure.

In a possible implementation, when the matching probability information of the candidate matching result is determined, a sum of matching probabilities of the m candidate pairs in the candidate matching result may be determined as a matching probability corresponding to the matching probability information of the candidate matching result.

Exemplarily, when a certain candidate matching result includes three candidate pairs and each candidate pair has a matching probability, i.e., a probability 1, a probability 2 and a probability 3 respectively, a matching probability of the candidate matching result is a sum of the probability 1, the probability 2 and the probability 3.

In another possible implementation, a sum of weighted matching probabilities of the m candidate pairs may also be determined as the matching probability of the candidate matching result. Or, the matching probabilities of the m candidate pairs may also be processed in another manner to obtain the matching probability of the candidate matching result. For example, the matching probability of the candidate matching result is equal to an average, maximum or minimum of the matching probabilities of the m candidate pairs. No limits are made thereto in the embodiment of the disclosure.

After the matching probability information of each of the at least one candidate matching result is obtained, the target matching result may be determined from among the at least one candidate matching result based on the matching probability information of each candidate matching result. As an implementation, the candidate matching result having matching probability information corresponding to a maximum matching probability may be determined from among the at least one candidate matching result as the target matching result. Or, the target matching result may be determined from among the at least one candidate matching result through a preset threshold. No limits are made thereto in the embodiment of the disclosure.

In the example shown in FIG. 3, an overall matching condition of the at least one face and at least one human body in the first image is determined at first, and then a human body matching condition of the first face of the at least one face is determined according to the overall matching condition, so that matching results of all the faces and human bodies in the first image may be obtained at one time, and the image processing efficiency may be improved, particularly under the condition that analysis processing is required to be performed on at least the majority of the faces in the first image.

In some other possible implementations, the human body matching the first face in the at least one human body may be determined according to the matching probability information of the first face and each human body in the at least one human body of the first image, but the embodiment of the disclosure is not limited thereto.

In some embodiments, before the operation that it is determined whether the at least one human body corresponding to the first image includes the human body matching the first face, the method further includes that: human body tracking is performed on at least part of images in the video sequence to which the first image belongs to obtain the human body tracking result of the video sequence; and the human body tracking result of the video sequence is searched for the human body tracking information of the first image based on the frame number of the first image.

In some embodiments, before the operation that it is determined whether the at least one human body corresponding to the first image includes the human body matching the first face, the method further includes that: human body detection is performed on the first image to obtain the at least one human body corresponding to the first image.

In some embodiments, the method further includes that: responsive to not finding the human body tracking information of the first image in the human body tracking result of the video sequence, human body detection is performed on the first image to obtain the at least one human body corresponding to the first image.

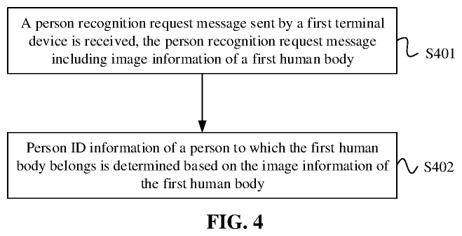

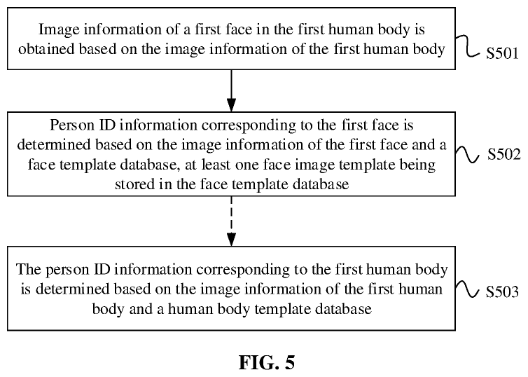

An embodiment of the disclosure provides another image processing method, as shown in FIG. 4. An execution body of the method is a server or any other device capable of implementing person recognition. For ease of understanding, descriptions will be made below with execution of the method by the server as an example. However, the embodiment of the disclosure is not limited thereto.

In S401, a person recognition request message sent by a first terminal device is received, the person recognition request message including image information of a first human body.

In a possible implementation, the first terminal device may be the terminal device in FIG. 1, but the embodiment of the disclosure is not limited thereto.

In some embodiments, the person recognition request message may be the first person recognition request message obtained based on face detection or tracking in the abovementioned embodiments or the second person recognition request message obtained based on human body detection or tracking in the abovementioned embodiments. No limits are made thereto in the embodiment of the disclosure.

In S402, person ID information of a person to which the first human body belongs is determined based on the image information of the first human body.

The server determines the person ID information based on the image information of the first human body in the person recognition request message. In a person recognition process of the server, one or more of the following three databases may be involved: a face template database, a human body template database and an association database.

The face template database is configured to store at least one face template, the face template may include a face image or face feature information and has person ID information of a corresponding person, for example, a person ID (person-id), and the person ID may uniquely identify a person. The human body template database is configured to store at least one human body template, the human body template may include a human body image or human body feature information and has person ID information of a corresponding person, for example, a human body ID (body-id or Re-Id), and the human body ID may be configured to uniquely identify a human body.

The association database is configured to store a corresponding relationship between face-based first person ID information (for example, person ID) and a human-body-based second person ID information (for example, human body ID). Or, the human-body-based second person ID information is referred to as human body ID information, and in such case, the association database is configured to store a corresponding relationship between person ID information and human body ID information. For example, the association database may include multiple records, and each record includes a human body ID and a person ID corresponding to the human body ID.

In addition, any one or more of the face template, the human body template and the association database may be manually input, or obtained based on manually input information, for example, obtained by performing feature extraction on a manually input face image, or dynamically updated in the person recognition process. No limits are made thereto in the embodiment of the disclosure.

Specific implementation of S402 under different contents of the person recognition request message will be described below in detail.

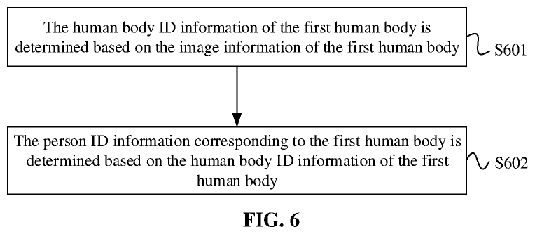

An embodiment of the disclosure provides another image processing method, as shown in FIG. 5. In the example, there is made such a hypothesis that the person recognition request message received by the server is the first person recognition request message. In such case, the server may perform face-based person recognition through S501 and S502, or perform human-body-based person recognition through S503 or combine face-based person recognition and human-body-based person recognition to obtain a final person recognition result.

In S501, image information of a first face in the first human body is obtained based on the image information of the first human body.

In some embodiments, the image information of the first human body includes an image of the first human body. In such case, the server may acquire an image of the first face from the image of the first human body. In an example, the server may perform face detection on the image of the first human body to obtain the image of the first face. Or, the server may acquire position information of the first face and acquire the image of the first face from the image of the first human body based on the position information of the first face. For example, the first person recognition request message includes the position information of the first face, or, the first person recognition request message includes key point information of the first face, etc. Specific implementation of the operation that the server acquires the image of the first face is not limited in the embodiments of the disclosure. In some embodiments, the image information of the first human body includes human body feature information of the image of the first human body and/or face feature information of the image of the first human body. In such case, the server may acquire the face feature information in the image information of the first human body. However, the embodiment of the disclosure is not limited thereto.

In S502, person ID information of a person to which the first human body belongs is determined based on the image information of the first face and a face template database. In some embodiments, the server may determine whether there is a face template matching the image information of the first face in the face template database.

In a possible implementation, the image information of the first face includes the image of the first face. In such case, in an example, the face template in the face template database includes face feature information, and then the server may perform feature extraction processing on the image of the first face to obtain feature information of the first face and determine whether there is the face template matching the feature information of the first face in the face template database based on a similarity or distance between the feature information of the first face and face feature information in at least one face template. In another example, the face template in the face template database includes a face image, and then the server may determine whether there is the face template matching the image of the first face in the face template database based on a similarity between the image of the first face and the at least one face template in the face template database.

In another possible implementation, the image information of the first face includes face feature information of the image of the first human body, and correspondingly, the server may determine whether there is the face template matching the image information of the first face in the face template database based on the face feature information of the image of the first human body. Specific implementation of determining whether there is the face template matching the image information of the first face in the face template database is not limited in the embodiments of the disclosure. Then, the server may obtain the person ID information of the person to which the first human body belongs based on a determination result. As an example, the person ID information of the person to which the first human body belongs includes a person ID.

As an example, the determination result is that there is the face template matching the image information of the first face in the face template database. In such case, as an implementation, the server determines person ID information corresponding to the matching face template as the person ID information of the person to which the first human body belongs.

In some embodiments, each face template in the face template database corresponds to a person ID, so that, if there is the face template matching the image information of the first face in the face template database, it is indicated that the person corresponding to the first face is a person that has been recorded in the server. In such case, as an implementation, the server may add 1 to an occurrence frequency of the person or record information about present occurrence of the person, for example, one or more of time information, place information, corresponding camera information and an acquired image. No limits are made thereto in the embodiment of the disclosure.

As another example, the determination result is that there is no face template matching the image information of the first face in the face template database. In such case, as an implementation, the server may add new person ID information, for example, adding a new person ID, and determine the newly added person ID information as the person ID information of the person to which the first human body belongs.

If there is no face template matching the feature information of the first face in the face template database, the server may confirm that the person to which the first face belongs is a new person and allocates newly added person ID information to the new person.

In some embodiments, the server, after allocating the person ID information to the new person, may add the newly added person ID information and the image information of the first face to the face template database together. As an implementation, the newly added person ID information and the image information of the first face may be added to the face template database as a new record, thereby establishing a corresponding relationship between the newly added person ID information and the image information of the first face. Or, the server may also add the image information of the first face to the face template database and record the corresponding relationship between the image information of the first face and the newly added person ID information.

In S503, the person ID information of the person to which the first human body belongs is determined based on the image information of the first human body and a human body template database.

In some embodiments, the image information of the first human body includes the image of the first human body. In such case, in an example, the human body template in the human body template database includes human body feature information, and then the server may perform feature extraction processing on the image of the first human body to obtain feature information of the first human body and determine whether there is a human body template matching the feature information of the first human body in the human body template database based on a similarity or distance between the feature information of the first human body and human body feature information in at least one human body template.

In another example, the human body template in the human body template database includes a human body image, and then the server may determine whether there is the human body template matching the image of the first human body in the human body template database based on a similarity between the image of the first human body and the at least one human body template in the human body template database.

In another possible implementation, the image information of the first human body includes human body feature information of the image of the first human body, and correspondingly, the server may determine whether there is the human body template matching the image information of the first human body in the human body template database based on the human body feature information of the image of the first human body. Specific implementation of determining whether there is the human body template matching the image information of the first human body in the human body template database is not limited in the embodiments of the disclosure.

Then, the server may obtain the person ID information of the person to which the first human body belongs based on a determination result. As an example, the person ID information of the person to which the first human body belongs includes a human body ID.

As an example, the determination result is that there is the human body template matching the image information of the first human body in the human body template database. In such case, as an implementation, the server determines second person ID information corresponding to the matching human body template as the person ID information of the person to which the first human body belongs. Or, the server may also query first person ID information corresponding to the second person ID information corresponding to the matching human body template in the association database and determine the queried first person ID information as the person ID information of the person to which the first human body belongs.

In some embodiments, each human body template in the human body template database corresponds to a human body ID, so that, if there is the human body template matching the image information of the first human body in the human body template database, it is indicated that the first human body is a human body that has been recorded in the server. In such case, as an implementation, the server may add 1 to an occurrence frequency of the human body or record information about present occurrence of the human body, for example, one or more of time information, place information, corresponding camera information and an acquired image. No limits are made thereto in the embodiment of the disclosure.

As another example, the determination result is that there is no human body template matching the image information of the first human body in the human body template database. In such case, as an implementation, the server may add new second person ID information or human body ID information, for example, adding a new human body ID, and determine the newly added second person ID information as the person ID information of the person to which the first human body belongs. If there is no human body template matching the feature information of the first human body in the human body template database, the server may confirm that the person to which the first human body belongs is a new person and allocate newly added person ID information to the new person.

In some embodiments, the server, after allocating the second person ID information to the new person, may add the newly added second person ID information and the image information of the first human body to the human body template database together. As an implementation, the newly added person ID information and the image information of the first human body may be added to the human body template database as a new record, thereby establishing a corresponding relationship between the newly added second person ID information and the image information of the first human body. Or, the server may also add the image information of the first human body to the human body template database and record the corresponding relationship between the image information of the first human body and the newly added second person ID information.

In another possible implementation, the server performs face-based person recognition and human-body-based person recognition, after obtaining the face-based first person ID information (for example, the person ID) and the human-body-based second person ID information (for example, the human body ID), establishes the corresponding relationship between the first person ID information and the second person ID information and adds the corresponding relationship between the first person ID information and the second person ID information to the association database. However, the embodiment of the disclosure is not limited thereto. In some embodiments, the first person recognition request message may further include the ID information of the first face in the first human body, for example, bounding box ID information or tracking ID information. The server may perform further identity recognition, customer flow analysis and the like according to bounding box information or tracking ID information of the first face.

An embodiment of the disclosure provides another image processing method, as shown in FIG. 6. In the example, there is made such a hypothesis that the person recognition request message received by the server is the second person recognition request message.

In S601, the human body ID information of the first human body (or the second person ID information) is determined based on the image information of the first human body. In this implementation, the server may determine the human body ID information of the first human body or the second person ID information based on the image information of the first human body and the human body template database. In S602, the person ID information of the person to which the first human body belongs is determined based on the human body ID information of the first human body (or the second person ID information).

In some embodiments, after the human body ID information of the first human body is determined, the server may determine the person ID information of the person to which the first human body belongs in the following manner: it is determined whether there is an association relationship matching the human body ID information of the first human body in the association database, the association database being configured to store at least one association relationship between human body ID information and person ID information; and the person ID information of the person to which the first human body belongs is obtained based on a determination result.

In some embodiments, if there is the association relationship matching the human body ID information of the first human body in the association database, the server may determine person ID information (or referred to as first person ID information) in the matching association relationship as the person ID information of the person to which the first human body belongs. If there is the association relationship matching the human body ID of the first human body in the association database, it is indicated that the person to which the first human body belongs is a person that has been stored in the server, and the server may determine a person corresponding to a person ID corresponding to the human body ID of the first human body is the person to which the first human body belongs. In some embodiments, if there is no association relationship matching the human body ID information of the first human body in the association database, the newly added person ID information is determined as the person ID information of the person to which the first human body belongs. If there is no association relationship matching the human body ID information of the first human body in the association database, the server may confirm that the person to which the first human body belongs is a new person, and the new person may correspond to new person ID information.

For each abovementioned embodiment, as an implementation, after the server determines the person ID information of the first human body, the person ID information of the person to which the first human body belongs may be sent to a second terminal device. The second terminal device may be, for example, a terminal device owned by a certain merchant. The second terminal device may perform processing such as customer flow statistics, customer recognition and customer visit counting based on the person ID information of the person to which the first human body belongs. No limits are made thereto in the embodiment of the disclosure.

In another embodiment, when the message received by the server only includes a face, the face may be recognized according to the face template database. In some embodiments, the server may perform matching processing on the face and the face template in the face template database and perform recognition according to a determination result. In some embodiments, if there is a face template matching the face in the face template database, the server may determine that person ID information of a person to which the face belongs is person ID information corresponding to the matching face template. In some embodiments, if there is no face template matching the face in the face template database, the server may add feature information of the face to the face template database and allocate the person ID information of the person to which the face belongs.

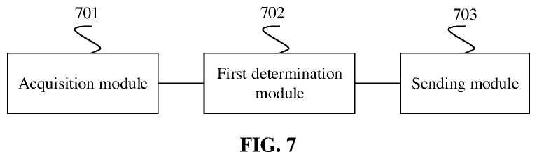

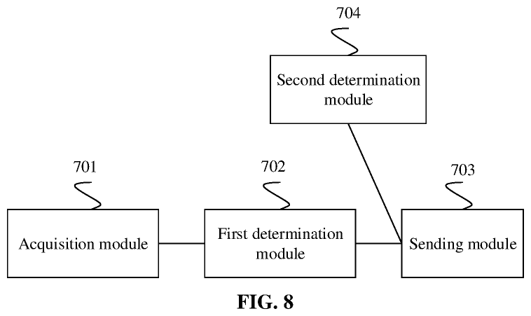

An embodiment of the disclosure provides an image processing apparatus. As shown in FIG. 7, the apparatus includes: an acquisition module 701, configured to process a first image to obtain a first face in the first image; a first determination module 702, configured to determine whether at least one human body corresponding to the first image includes a human body matching the first face; and a sending module 703, configured to send a first person recognition request message to a server according to a determination result.

In another embodiment, the sending module 703 is configured to: responsive to that the at least one human body corresponding to the first image includes a first human body matching the first face, send the first person recognition request message including image information of the first human body to the server, the image information of the first human body being used by the server for performing person recognition.

An embodiment of the disclosure provides another image processing apparatus. As shown in FIG. 8, the apparatus further includes a second determination module 704, configured to: responsive to that the at least one human body corresponding to the first image includes the first human body matching the first face, determine, according to image quality of the first human body, whether or not to include the image information of the first human body in the first person recognition request message.

In another embodiment, the sending module 703 is configured to: responsive to that the image quality of the first human body meets a quality requirement, send the first person recognition request message including the image information of the first human body to the server.

In another embodiment, the quality requirement includes at least one of a face definition requirement, a face size requirement, a face angle requirement, a face detection confidence requirement, a human body detection confidence or whether a whole face is included.

In another embodiment, the sending module 703 is configured to: responsive to that the image quality of the first human body does not meet the quality requirement, send the first person recognition request message including image information of the first face to the server, the image information of the first face being used by the server for performing person recognition.

In another embodiment, the first person recognition request message further includes tracking ID information of the first face or bounding box ID information of the first face. In another embodiment, the image information of the first human body includes an image of the first human body; and/or, the image information of the first human body includes feature information of the image of the first human body, the feature information of the image of the first human body including at least one of human body feature information or face feature information.

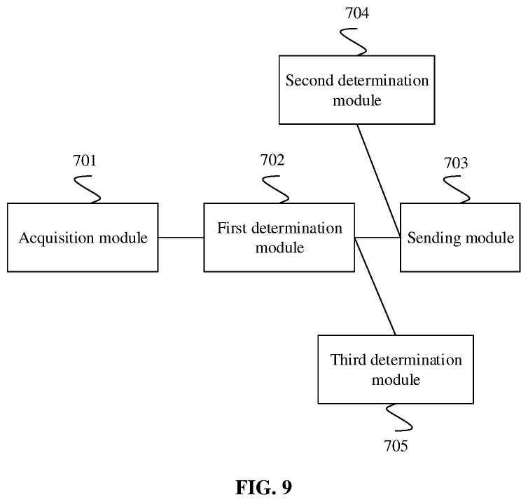

An embodiment of the disclosure provides another image processing apparatus. As shown in FIG. 9, the apparatus further includes a third determination module 705, configured to determine to replace the image information of the first face with the image information of the first human body for performing person recognition.

In another embodiment, the sending module 703 is further configured to: responsive to that the at least one human body corresponding to the first image does not include the human body matching the first face, send the first person recognition request message including the image information of the first face to the server, the image information of the first face being used by the server for performing person recognition.

In another embodiment, the first determination module 702 is configured to determine whether the at least one human body corresponding to the first image includes the human body matching the first face.

In another embodiment, the first determination module 702 is configured to: determine matching probability information of each of N candidate pairs according to at least one face and at least one human body corresponding to the first image, the candidate pair including a face of the at least one face and a human body of the at least one human body, the at least one face including the first face; determine a target matching result between the at least one face and the at least one human body according to the matching probability information of each of the N candidate pairs; and determine whether the at least one human body corresponding to the first image includes the human body matching the first face based on the target matching result.

In another embodiment, the first determination module 702 is configured to determine estimated position information and actual position information of a target object based on a second human body in a first candidate pair and a second face in the first candidate pair, the N candidate pairs including the first candidate pair and the target object being a part of the human body, and determine the matching probability information of the first candidate pair based on the estimated position information of the target object and the actual position information of the target object.

In another embodiment, the target object includes at least one of an ear or a face.

In another embodiment, the first determination module 702 is configured to: determine matching probability information of each of at least one candidate matching result between the at least one face and the at least one human body according to the matching probability information of each of the N candidate pairs, the candidate matching result including m of the N candidate pairs, every two of the m candidate pairs including different faces and different human bodies, where 1≤m≤N; and determine the target matching result between the at least one face and the at least one human body from among the at least one candidate matching result based on the matching probability information of each of the at least one candidate matching result.

In another embodiment, the first determination module 702 is configured to: perform human body tracking on at least part of images in a video sequence to which the first image belongs to obtain a human body tracking result, the human body tracking result including human body tracking information of at least one image in the video sequence; and determine whether the at least one human body corresponding to the first image includes the human body matching the first face based on the human body tracking information corresponding to a frame number of the first image in the human body tracking result of the at least part of images in the video sequence. In another embodiment, the first determination module 702 is configured to: responsive to that the human body tracking result does not include the human body tracking information corresponding to the frame number of the first image, determine whether the at least one human body obtained by performing human body detection on the first image includes the human body matching the first face.

In another embodiment, the apparatus further includes: a human body tracking module, configured to perform human body tracking on at least part of images in the video sequence to which the first image belongs to obtain the human body tracking result of the video sequence; and a tracking information searching module, configured to search the human body tracking result of the video sequence for the human body tracking information of the first image based on the frame number of the first image.

In another embodiment, the apparatus further includes a human body detection module, configured to perform human body detection on the first image to obtain the at least one human body corresponding to the first image.

In another embodiment, the apparatus further includes: the human body tracking module, configured to perform human body tracking on at least part of images in the video sequence to which the first image belongs to obtain the human body tracking result of the video sequence; and the tracking information searching module, configured to search the human body tracking result of the video sequence for the human body tracking information of the first image based on the frame number of the first image.

In another embodiment, the apparatus further includes the human body detection module, configured to: responsive to not finding the human body tracking information of the first image in the human body tracking result of the video sequence, perform human body detection on the first image to obtain the at least one human body corresponding to the first image.

In another embodiment, the acquisition module 701 is configured to perform face tracking on the first image to obtain the first face in the first image.

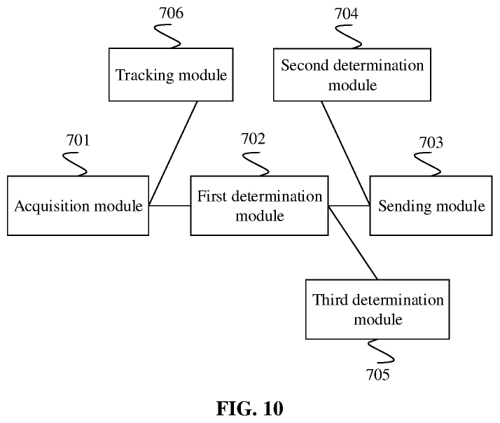

An embodiment of the disclosure provides another image processing apparatus. As shown in FIG. 10, the apparatus further includes a tracking module 706, configured to perform human body tracking on the first image to obtain a third human body in the first image. The sending module 703 is further configured to send a second person recognition request message to the server, the second person recognition request message including image information of the third human body and tracking ID information of the third human body.

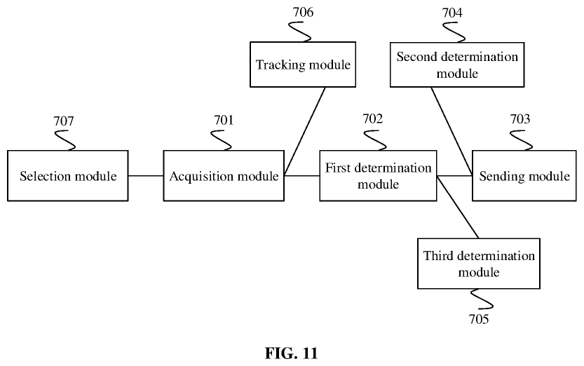

An embodiment of the disclosure provides another image processing apparatus. As shown in FIG. 11, the apparatus further includes a selection module 707, configured to select the first image from a preset number of consecutive images in the video sequence. In another embodiment, the selection module 707 is configured to select the first image from the preset number of consecutive images in the video sequence based on quality of faces in the images.

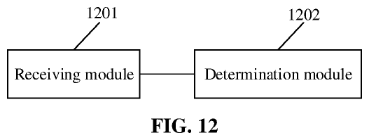

An embodiment of the disclosure provides another image processing apparatus. As shown in FIG. 12, the apparatus includes: a receiving module 1201, configured to receive a person recognition request message sent by a first terminal device, the person recognition request message including image information of a first human body; and a determination module 1202, configured to determine person ID information of a person to which the first human body belongs based on the image information of the first human body.

In another embodiment, the image information of the first human body includes an image of the first human body; and/or, the image information of the first human body includes feature information of the image of the first human body, the feature information of the image of the first human body including at least one of human body feature information or face feature information.

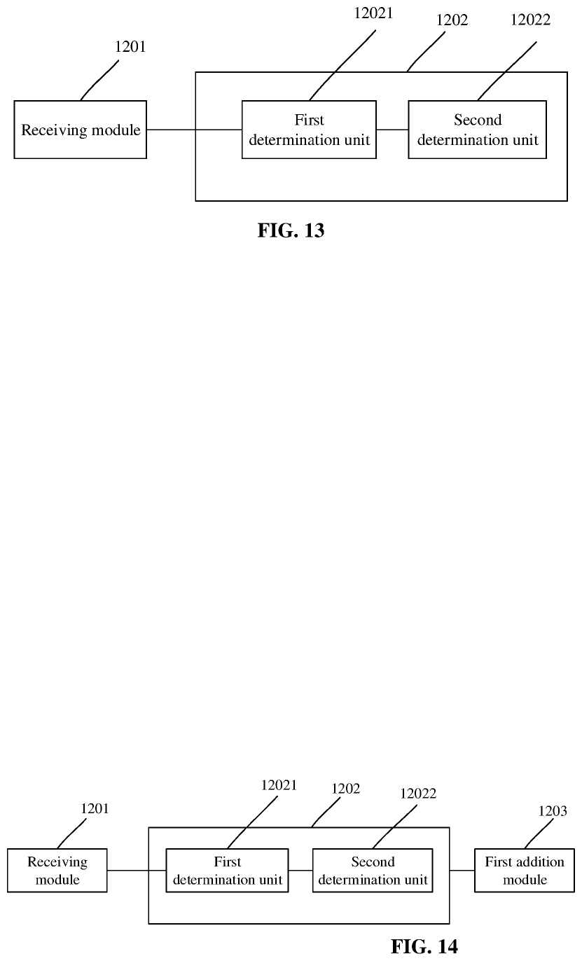

An embodiment of the disclosure provides another image processing apparatus. As shown in FIG. 13, the determination module 1202 includes: a first determination unit 12021, configured to obtain image information of a first face included in the first human body based on the image information of the first human body; and a second determination unit 12022, configured to determine the person ID information of the person to which the first human body belongs based on the image information of the first face and a face template database, at least one face template being stored in the face template database.

In another embodiment, the first determination unit 12021 is configured to acquire an image of the first face from the image of the first human body. In another embodiment, the second determination unit 12022 is configured to perform feature extraction processing on the image of the first face to obtain feature information of the first face, determine whether there is a face template matching the feature information of the first face in the face template database and obtain the person ID information of the person to which the first human body belongs based on a determination result. In another embodiment, the second determination unit 12022 is configured to: responsive to that there is the face template matching the feature information of the first face in the face template database, determine person ID information corresponding to the matching face template as the person ID information of the person to which the first human body belongs. In another embodiment, the second determination unit 12022 is configured to: responsive to that there is no face template matching the feature information of the first face in the face template database, determine newly added person ID information as the person ID information of the person to which the first human body belongs.

An embodiment of the disclosure provides another image processing apparatus. As shown in FIG. 14, the apparatus further includes a first addition module 1203, configured to add the newly added person ID information and information of the first face (for example, the feature information of the first face) to the face template database as a new face template. In another embodiment, the person recognition request message further includes bounding box ID information or tracking ID information of the first face in the first human body.

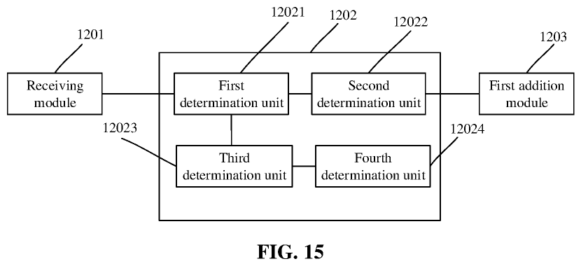

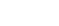

An embodiment of the disclosure provides another image processing apparatus. As shown in FIG. 15, the determination module 1202 further includes: a third determination unit 12023, configured to determine human body ID information of the first human body based on the image information of the first human body; and a fourth determination unit 12024, configured to determine the person ID information of the person to which the first human body belongs based on the human body ID information of the first human body.

In another embodiment, the third determination unit 12023 is configured to perform feature extraction on the image of the first human body to obtain feature information of the first human body, determine whether there is a human body template matching the feature information of the first human body in a human body template database, at least one human body template being stored in the human body template database, and obtain the human body ID information of the first human body based on a determination result. In another embodiment, the third determination unit 12023 is configured to: responsive to that there is the human body template matching the feature information of the first human body in the human body template database, determine human body ID information corresponding to the matching human body template as the human body ID information of the first human body. In another embodiment, the third determination unit 12023 is configured to: responsive to that there is no human body template matching the feature information of the first human body in the human body template database, determine newly added human body ID information as the human body ID information of the first human body.

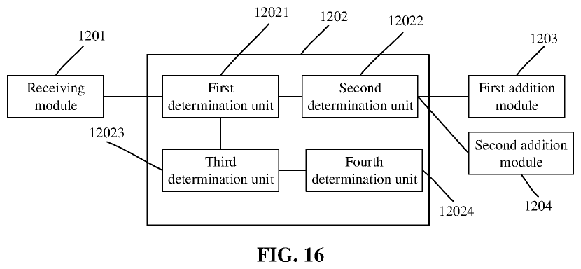

An embodiment of the disclosure provides another image processing apparatus. As shown in FIG. 16, the apparatus further includes a second addition module 1204, configured to add the newly added human body ID information and information of the first human body to the human body template database as a new face template.

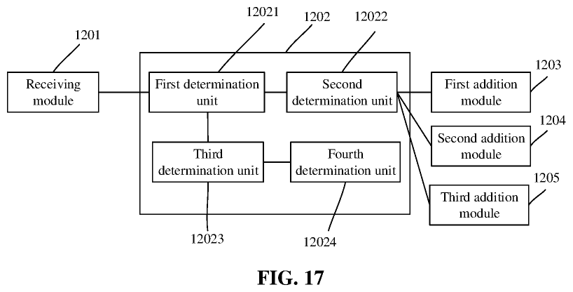

An embodiment of the disclosure provides another image processing apparatus. As shown in FIG. 17, the apparatus further includes a third addition module 1205, configured to add, to an association database, the human body ID information of the first human body as well as an association relationship between the person ID information of the person to which the first human body belongs and the human body ID information of the person to which the first human body belongs.

In another embodiment, the person recognition request message further includes tracking ID information or bounding box ID information of the first human body. In another embodiment, the fourth determination unit 12024 is configured to determine whether there is an association relationship matching a human body ID of the first human body in the association database, the association database being configured to store at least one association relationship between human body ID information and person ID information, and obtain the person ID information of the person to which the first human body belongs based on a determination result. In another embodiment, the fourth determination unit 12024 is configured to: responsive to that there is the association relationship matching the human body ID of the first human body in the association database, determine person ID information in the matching association relationship as the person ID information of the person to which the first human body belongs. In another embodiment, the fourth determination unit 12024 is configured to: responsive to that there is no association relationship matching the human body ID of the first human body in the association database, determine the newly added person ID information in the matching association relationship as the person ID information of the person to which the first human body belongs.

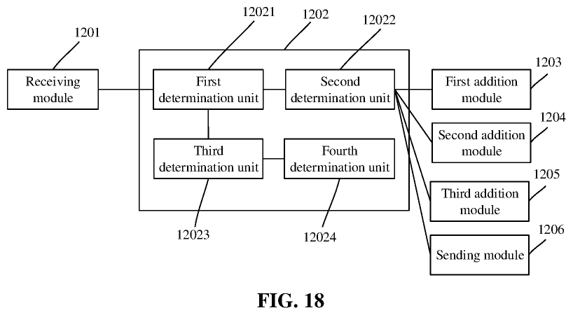

An embodiment of the disclosure provides another image processing apparatus. As shown in FIG. 18, the apparatus further includes a sending module 1206, configured to send the person ID information of the person to which the first human body belongs to a second terminal device. In another embodiment, the person recognition request message is obtained by performing face tracking on at least one image in a video sequence by the first terminal device.

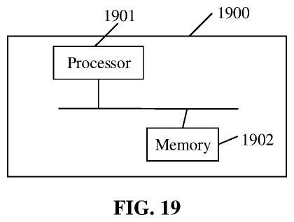

An embodiment of the disclosure provides a terminal device. As shown in FIG. 19, the terminal device 1900 includes: a memory 1901, configured to store a program instruction; and a processor 1902, configured to invoke and execute the program instruction in the memory 1901 to perform the operations of the method executed by the client in the method embodiments.

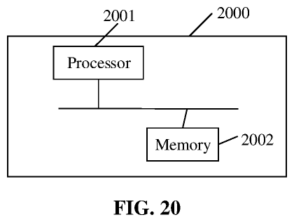

An embodiment of the disclosure provides a server. As shown in FIG. 20, the server 2000 includes: a memory 2002, configured to store a program instruction; and a processor 2001, configured to invoke and execute the program instruction in the memory 2002 to perform the operations of the method executed by the server in the method embodiments.

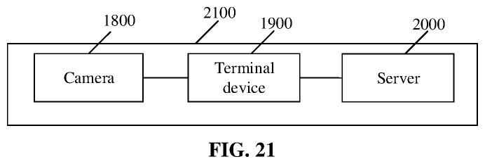

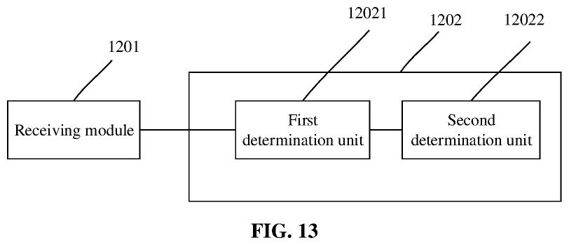

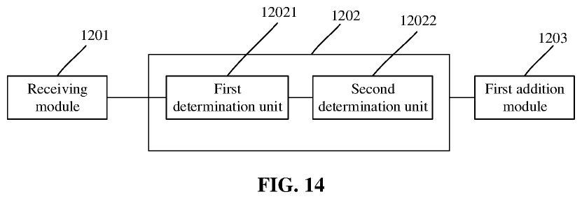

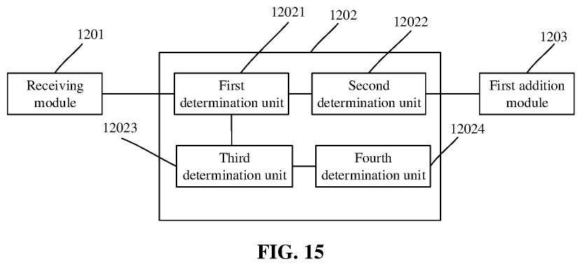

An embodiment of the disclosure provides an image processing system. As shown in FIG. 21, the system 2100 includes a camera 1800, terminal device 1900 and server 2000 in communication connection. In an implementation process, the camera 1800 shoots a video image in real time and sends it to the terminal device 1900. The terminal device performs processing such as tracking and matching according to the video image to obtain human body information and face information and sends the information to the server 2000. The server further performs recognition processing according to the received information.

It can be understood by those of ordinary skill in the art that all or part of the operations of each method embodiment may be completed by instructing related hardware through a program. The program may be stored in a computer-readable storage medium. The program is executed to perform the operations of each method embodiment. The storage medium includes various media capable of storing program codes such as a ROM, a RAM, a magnetic disk or an optical disk. It is finally to be noted that: the above embodiments are adopted not to limit but only to describe the technical solutions of the disclosure. Although the disclosure is described with reference to each embodiment in detail, those of ordinary skill in the art should know that modifications may also be made to the technical solutions recorded in each embodiment or equivalent replacements may be made to part or all of technical features therein. These modifications or replacements do not make the essence of the corresponding technical solutions depart from the scope of the technical solutions of each embodiment of the disclosure.

1. An image processing method, comprising:
processing a first image to obtain a first face in the first image;
determining whether at least one human body corresponding to the first image comprises a human body matching the first face; and
sending a first person recognition request message to a server according to a determination result.

2. The method of claim 1, wherein sending the first person recognition request message to the server according to the determination result comprises:
responsive to that the at least one human body corresponding to the first image comprises a first human body matching the first face, sending the first person recognition request message comprising image information of the first human body to the server, wherein the image information of the first human body is used by the server for performing person recognition.

3. The method of claim 2, further comprising: responsive to that the at least one human body corresponding to the first image comprises the first human body matching the first face and that the image quality of the first human body meets a quality requirement, sending the first person recognition request message comprising the image information of the first human body to the server.

4. The method of claim 1, wherein the first person recognition request message further comprises Identification (ID) information of the first face.

5. The method of claim 1, wherein sending that the first person recognition request message to the server according to the determination result comprises: responsive to that the at least one human body corresponding to the first image does not comprise the human body matching the first face, or responsive to that the at least one human body corresponding to the first image comprises a first human body matching the first face and that the image quality of the first human body does not meet a quality requirement, sending the first person recognition request message comprising image information of the first face to the server, wherein the image information of the first face is used by the server for performing person recognition.

6. The method of claim 1, wherein determining whether the at least one human body corresponding to the first image comprises the human body matching the first face comprises:
determining matching probability information of each of N candidate pairs according to at least one face and at least one human body corresponding to the first image, wherein the candidate pair comprises a face of the at least one face and a human body of the at least one human body, the at least one face comprising the first face;
determining a target matching result between the at least one face and the at least one human body according to the matching probability information of each of the N candidate pairs; and
determining, based on the target matching result, whether the at least one human body corresponding to the first image comprises the human body matching the first face.

7. The method of claim 6, wherein determining the matching probability information of each of the N candidate pairs according to the at least one face and the at least one human body comprises:
determining estimated position information and actual position information of a target object based on a second human body in a first candidate pair and a second face in the first candidate pair, wherein the N candidate pairs comprise the first candidate pair and the target object is a part of the human body; and
determining matching probability information of the first candidate pair based on the estimated position information of the target object and the actual position information of the target object.

8. The method of claim 6, wherein determining the target matching result between the at least one face and the at least one human body according to the matching probability information of each of the N candidate pairs comprises:
determining matching probability information of each of at least one candidate matching result between the at least one face and the at least one human body according to the matching probability information of each of the N candidate pairs, wherein the at least one candidate matching result comprises m of the N candidate pairs, and every two of the m candidate pairs comprise different faces and different human bodies, where 1≤m≤N; and
determining the target matching result between the at least one face and the at least one human body from among the at least one candidate matching result based on the matching probability information of each of the at least one candidate matching result.

9. The method of claim 1, before determining whether the at least one human body corresponding to the first image comprises the human body matching the first face, further comprising:
performing human body tracking on at least part of images in a video sequence to which the first image belongs, to obtain a human body tracking result; and
searching the human body tracking result of the video sequence for human body tracking information of the first image based on a frame number of the first image.

10. The method of claim 9, further comprising:
responsive to not finding the human body tracking information of the first image in the human body tracking result of the video sequence, performing human body detection on the first image to obtain the at least one human body corresponding to the first image.

11. An image processing method, comprising:
receiving a person recognition request message sent by a first terminal device, the person recognition request message comprising image information of a first human body; and
determining person Identification (ID) information of a person to which the first human body belongs based on the image information of the first human body.

12. The method of claim 11, wherein determining the person ID information of the person to which the first human body belongs based on the image information of the first human body comprises:
obtaining image information of a first face included in the first human body based on the image information of the first human body; and
determining the person ID information of the person to which the first human body belongs based on the image information of the first face and a face template database, wherein at least one face template is stored in the face template database.

13. The method of claim 11, wherein the person recognition request message further comprises bounding box ID information or tracking ID information of a first face in the first human body.

14. The method of claim 11, wherein determining the person ID information of the person to which the first human body belongs based on the image information of the first human body comprises:
determining human body ID information of the first human body based on the image information of the first human body; and
determining the person ID information of the person to which the first human body belongs based on the human body ID information of the first human body.

15. The method of claim 14, wherein determining the person ID information of the person to which the first human body belongs based on the human body ID information of the first human body comprises:
determining whether there is an association relationship matching a human body ID of the first human body in an association database, wherein the association database is configured to store at least one association relationship between human body ID information and person ID information; and
obtaining the person ID information of the person to which the first human body belongs based on a determination result.

16. The method of claim 15, wherein obtaining the person ID information of the person to which the first human body belongs based on the determination result comprises at least one of:
responsive to that there is the association relationship matching the human body ID of the first human body in the association database, determining person ID information in the matching association relationship as the person ID information of the person to which the first human body belongs; or
responsive to that there is no association relationship matching the human body ID of the first human body in the association database, determining newly added person ID information as the person ID information of the person to which the first human body belongs.

17. An image processing apparatus, comprising:
a memory storing processor-executable instructions; and
a processor arranged to execute the stored processor-executable instructions to perform operations of:
processing a first image to obtain a first face in the first image;
determining whether at least one human body corresponding to the first image comprises a human body matching the first face; and
sending a first person recognition request message to a server according to a determination result.

18. The apparatus of claim 17, wherein sending the first person recognition request message to the server according to the determination result comprises:
responsive to that the at least one human body corresponding to the first image comprises a first human body matching the first face, sending the first person recognition request message comprising image information of the first human body to the server, wherein the image information of the first human body is used by the server for performing person recognition.

19. An image processing apparatus, comprising:
a memory storing processor-executable instructions; and
a processor arranged to execute the stored processor-executable instructions to perform operations of the image processing method of claim 11.

20. A non-transitory computer-readable storage medium having stored thereon computer executable instructions that, when executed by a processor, cause the processor to perform an image processing method of claim 1.
